(19) United States
(12) Patent Application Publication
(10) Pub. No.: US 2012/0124179 A1
(43) Pub. Date: May 17, 2012

(54) TRAFFIC MANAGEMENT IN ADAPTIVE STREAMING PROTOCOLS

(75) Inventors: Adam Cappio, Seattle, WA (US); Amol Shukla, Shanghai (CN)

(73) Assignee: REALNETWORKS, INC., Seattle, WA (US)

(21) Appl. No.: 13/295,977

(22) Filed: Nov. 14, 2011

Related U.S. Application Data
(60) Provisional application No. 61/431,361, filed on Jan. 10, 2011.
(60) Provisional application No. 61/413,216, filed on Nov. 12, 2010.

(51) Int. Cl. G06F 15/16

(52) U.S. Cl. 709/219

(57) ABSTRACT

A proxy server manages media-data traffic in a network by leveraging the logical separation between the playlist and media segments in modern adaptive streaming protocols to redefine a media stream from an end client's perspective. In various embodiments, the media stream can be redefined from the client's perspective by dynamically modifying the playlist before the playlist is received by the end client and/or by dynamically modifying requests for media segments before the requests are forwarded to a media-origin server.

### CROSS REFERENCE TO RELATED APPLICATIONS

This application claims the benefit of priority to U.S. Provisional Application No. 61/413,216, filed Nov. 12, 2010, titled “TRAFFIC MANAGEMENT IN ADAPTIVE STREAMING PROTOCOLS,” having Attorney Docket No. REAL-2010252 (RN3XXP1), and naming the following inventors: Adam Cappio and Amol Shukla. This application also claims the benefit of priority to U.S. Provisional Application No. 61/431,361, filed Jan. 10, 2011, titled “TRAFFIC MANAGEMENT IN ADAPTIVE STREAMING PROTOCOLS,” having Attorney Docket No. REAL-2011255 (RN412P2), and naming the following inventors: Adam Cappio and Amol Shukla. The above-cited applications are incorporated herein by reference in their entireties, for all purposes.

### FIELD

This disclosure is related to networked computing, and more particularly, to media traffic management, bandwidth shaping, and/or HTTP adaptive rate limiting.

### BACKGROUND

Many recent adaptive streaming protocols, such as Apple HTTP Live Streaming, Microsoft IIS Smooth Streaming, 3GPP Dynamic Adaptive Streaming over HTTP (3GPP-DASH), MPEG HTTP streaming (MPEG-DASH), and the like, use a “playlist” file to describe a streaming media presentation to the client. The media is broken into segments, and the media stream is delivered (typically over HTTP) as a series of such segments. An end client obtains the playlist and media segments separately and the end client's view of the media presentation is based on the contents of the playlist and the actual media segments received.

Background information for adaptive media protocols may be found in standards and/or specifications related to 3GPP SA-4 HTTP Streaming, MPEG HTTP streaming, Open IPTV HTTP streaming, and those from other standard bodies working on adaptive streaming specifications and/or policy charging and rules function (PCRF).

In different adaptive streaming protocols, a “playlist” may be referred to using different terms, such as index file, manifest, media presentation description (MPD), or the like. The term “playlist” is used herein to refer to any such file that describes different media representations, such as alternate bitrates, resolutions, coding properties, languages, and the like. In some embodiments, for each media representation, a playlist may contain the URLs for the individual media segments, along with their sequence number (or similar timing and/or ordering information). In various embodiments, the URLs in the playlist can be either explicitly listed and/or an implicit template/pattern for constructing URLs can be provided in the playlist. XML or similar structured text (e.g., M3U, M3U8, and the like) is typically used as the file format for playlists.

For live events, a playlist is dynamically updated as content becomes available and new segments are created. Each protocol defines a mechanism for the end client to refresh its playlist (e.g., through an explicit field in the playlist or media segment). For non-live or on-demand streaming, the entire presentation is typically described in a single static playlist, and the end client typically has the responsibility to adapt to changing network or device conditions. For example, an end client may decide to switch to an alternate representation (e.g., a higher or lower bitrate) at a media segment boundary.

Existing traffic management solutions dynamically modify the media stream content itself. That is, the actual media stream received by the end client is modified in band. These in-band solutions may not scale well because they generally need to handle all media traffic destined for clients that are using it as a proxy.

Similarly, in-band solutions do not leverage the logical separation between a playlist and media segments in modern adaptive streaming protocols to dynamically modify the end client's view of the media stream.

### BRIEF DESCRIPTION OF THE DRAWINGS

FIG. 1 illustrates an exemplary traffic management system according to one embodiment.

FIG. 2 illustrates a proxy device in accordance with one embodiment.

FIG. 3 illustrates an exemplary series of application-layer communications between various devices in accordance with one playlist-modification embodiment.

FIG. 4 illustrates a playlist modification routine in accordance with one embodiment.

FIG. 5 illustrates an exemplary scenario in which a proxy processes playlist requests for various clients, in accordance with one embodiment.

FIGS. 6-7 illustrates an exemplary series of application-layer communications between various devices in accordance with various segment-request-modification embodiments.

FIG. 8 illustrates a media-segment-request modification routine in accordance with one embodiment.

FIG. 9 illustrates an exemplary scenario in which a proxy processes media-segment requests for various clients, in accordance with one embodiment.

FIG. 10 illustrates an exemplary series of application-layer communications between various devices in accordance with one securely-accessible playlist-modification embodiment.

FIG. 11 illustrates a securely-accessible playlist modification routine in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

In various embodiments, an end client's view of a media presentation in playlist-based adaptive streaming protocols may be dynamically modified to enable traffic management features such as bandwidth shaping, differentiated service, content control, ad insertion, and the like.

In accordance with various embodiments, traffic management ends may be achieved by leveraging the logical separation between the playlist and media segments in modern adaptive streaming protocols to modify the end client's view of the media. In various embodiments, the end client's view can be modified in at least two ways:
by changing the playlist delivered dynamically through the course of the presentation;
by changing requests for media segments that are forwarded to the origin server.

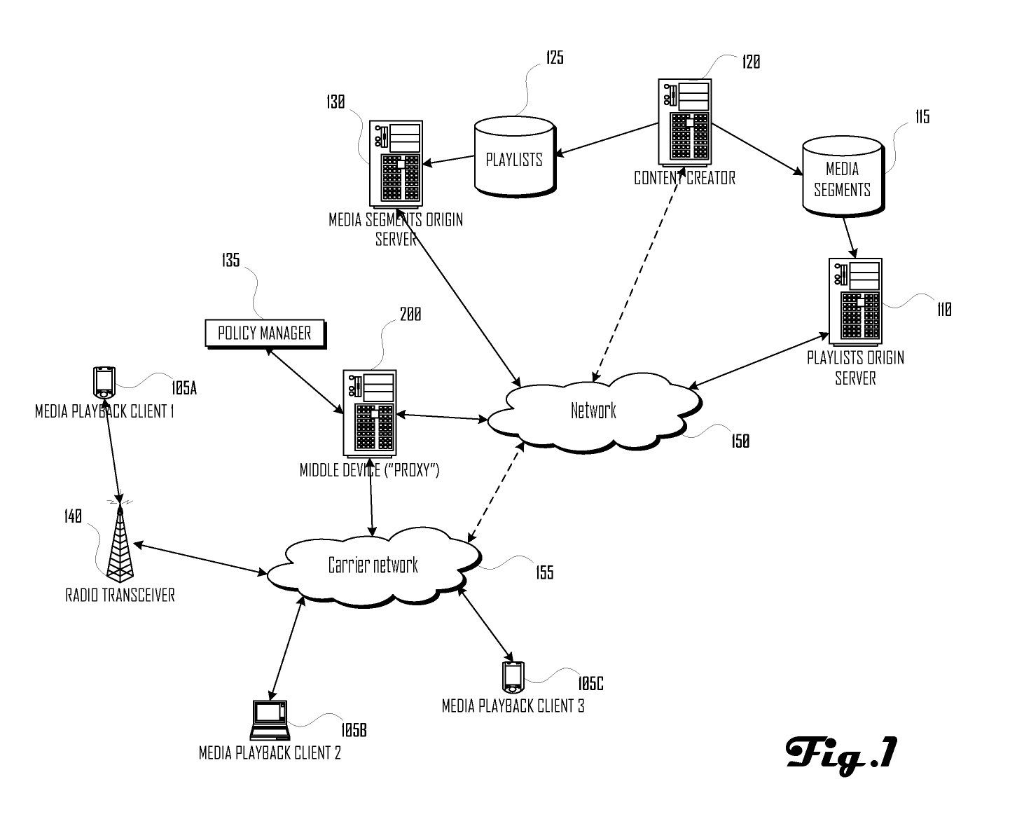

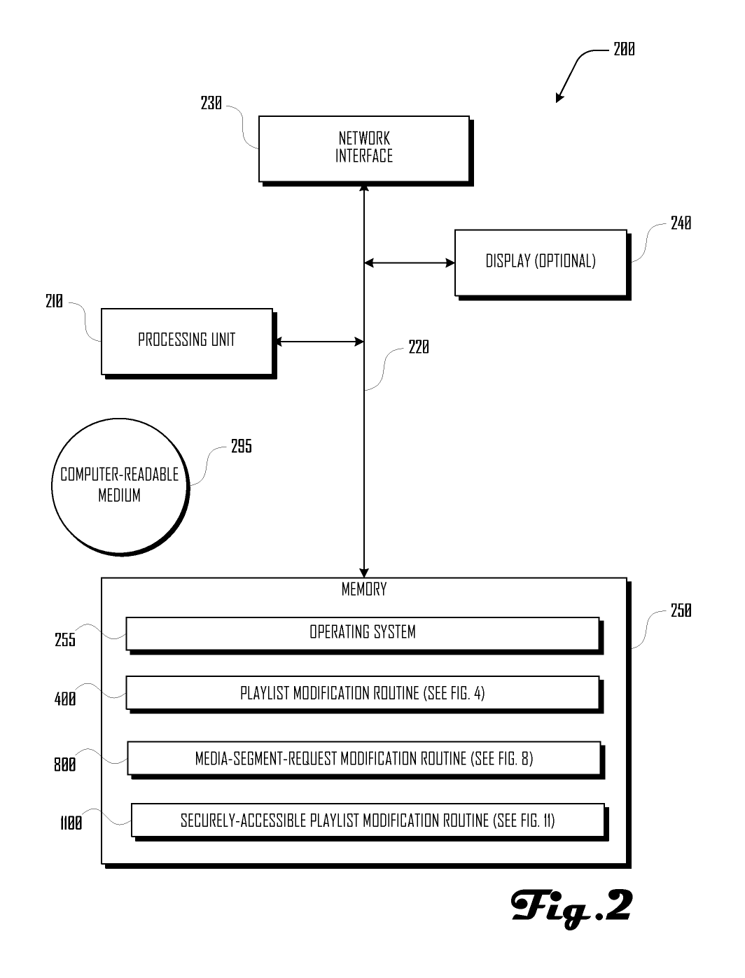

FIG. 1 illustrates an exemplary traffic management system 100 according to one embodiment in which media segments origin server 130, content creator device 120, playlists origin server 110, and a middle device or “proxy” 200 (see FIG. 2, discussed below) are connected to a network 150, such as the Internet. Additionally, a playlists data store 125 is writable by content creator 120 and readable by media segments origin server 130; and media segments data store 115 is writable by content creator 120 and readable by playlists origin server 110.

Additionally, client devices 105A-C and proxy 200 are connected to a carrier-provided network, such as a cellular or mobile data network and/or a broadband network. Proxy 200 is typically operated by (or with the consent of) the carrier, carrying data traffic between carrier network 155 and network 150, such as by acting as a gateway, proxy, or other device through which inter-network data traffic passes. In some embodiments, one or more client devices (e.g., client device 105A) may be connected to carrier network 155 via a radio transceiver 140 (e.g., a cell site tower, a Wi-Fi access point, and/or other wireless networking access point). In some embodiments, carrier network 155 and network 150 may also be connected via communication pathways that do not pass through proxy 200.

Proxy 200 also has access to a policy manager 135, which may be a software routine running on proxy 200, or on another device accessible to proxy 200 (possibly via network 150). As discussed below, policy manager 135 provides policy information related to media streams delivered to client devices 105A-C.

In some embodiments, other servers and/or devices (not shown) may also be present. For example, in some embodiments, one or more firewalls, and/or other intermediaries (not shown) may exist at various points on network 150 and/or carrier network 155.

Many traffic management use cases in broadband and mobile networks rely on modifying the media data delivered to end clients (e.g. client devices 105A-C) to achieve ends such as bandwidth shaping, content control, differentiated service, ad insertion, and the like. Such traffic management is typically performed at a middle box (e. g., proxy 200) between the end client (e.g. client devices 105A-C) and an origin server (e.g. origin server 130 and/or 110) with the consent of the carrier.

Thus, in some embodiments, proxy 200 mediates requests between the end client (e.g. client devices 105A-C) and an origin server (e.g. origin server 130 and/or 110). In one embodiment, client requests for playlist files may be proxied. In another embodiment, client requests for media segments may be proxied. In various embodiments, these approaches can be used together or separately.

In many embodiments, proxy 200 will be typically deployed as a middle box (e.g., carrier gateway). In alternate embodiments, proxy 200 can also be hosted at the origin server or the end client. In some embodiments, proxy 200 can be deployed in a service in conjunction with other components, for example, a cache to reduce upstream network traffic.

FIG. 2 illustrates several components of an exemplary proxy 200 in accordance with one embodiment. In some embodiments, proxy 200 may include many more components than those shown in FIG. 2. However, it is not necessary that all of these generally conventional components be shown in order to disclose an illustrative embodiment. As shown in FIG. 2, proxy 200 includes a network interface 230 for connecting to the network 150.

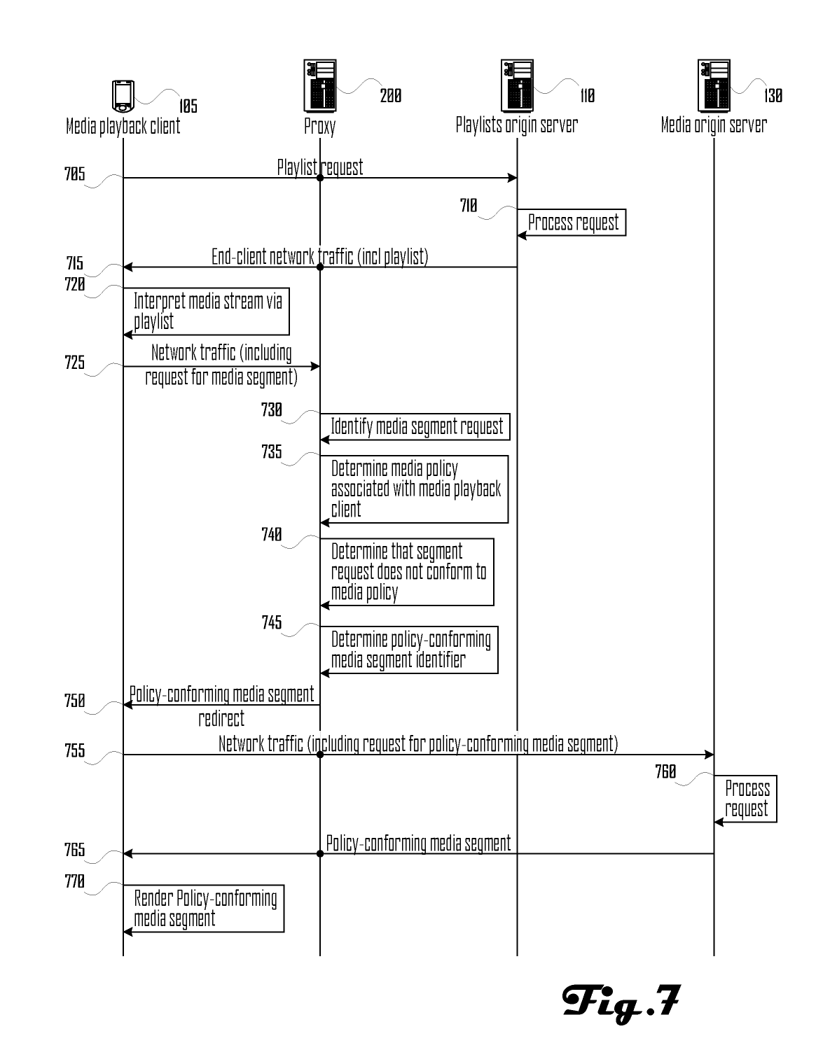

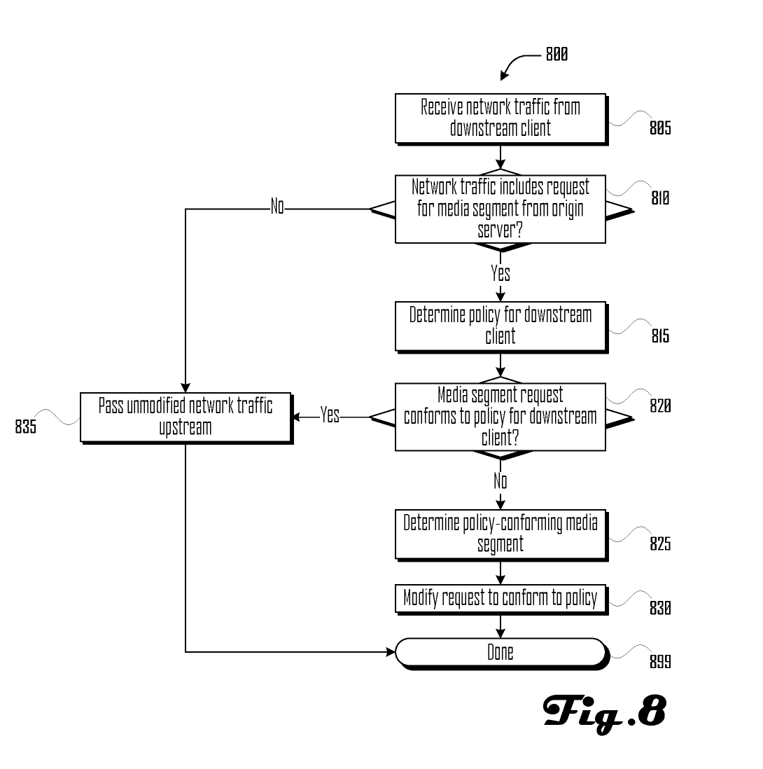

The proxy 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a playlist modification routine 700 (see FIG. 7, discussed above) and/or a media-segment-request modification routine 800 (see FIG. 8, discussed above). In addition, the memory 250 also stores an operating system 255. These software components may be loaded from a computer readable storage medium 295 into memory 250 of the proxy 200 using a drive mechanism (not shown) associated with a non-transient computer readable storage medium 295, such as a floppy disc, tape, DVD/CD-ROM drive, memory card, or the like. In some embodiments, software components may also be loaded via the network interface 230, rather than via a computer readable storage medium 295.

Although an exemplary proxy 200 has been described that generally conforms to conventional general purpose computing devices, an proxy 200 may be any of a great number of devices capable of communicating with the network 150 and managing media traffic, as discussed above.

Unlike in-band solutions discussed above, in various embodiments, only the playlist delivered to the end client or the media request forwarded to the origin server is dynamically modified. The actual media stream is delivered by the origin server to the end client without transcoding or other modification. Moreover, in various embodiments, the playlist seen by the end client is updated periodically (i.e., after startup) for purposes such as traffic management, ad insertion, and the like. That is, the end client's view of the available media is changed during the course of the presentation by the proxy for such purposes.

As the proxy only modifies the playlist delivered to the end client and/or requests sent to the origin server on an ongoing basis, the media stream delivered to the client need not be modified (e.g., through transcoding). As such, the approach disclosed herein may be scalable and able to operate at Internet scale in a cost-effective fashion.

In some embodiments, media segments can be added or removed from the playlist delivered to the end client by proxy 200. This can be done to enforce traffic shaping, content control, differentiated service, to insert ads, or for other like purposes.

For live streams, existing protocols already require end clients to refresh their playlist periodically or provide an explicit mechanism to trigger a refresh to get the latest content. Accordingly, in some embodiments, a proxy may be able to enforce the traffic management goals through the course of the presentation by providing an updated playlist during each refresh.

The end client's view of the media presentation can be similarly influenced through the course of an on-demand stream in at least the following ways.

For streaming protocols that use an explicit mechanism in the playlist to trigger a playlist refresh (e.g., an “UpdateAfter: 30 seconds” field), segments for the duration of the entire presentation can be announced in the playlist and this mechanism used to periodically trigger the refresh of the playlist by the end client. During each refresh, the playlist delivered to the end client can be modified. For streaming protocols that use an explicit mechanism by signaling a playlist refresh through a special flag in a media segment, segments for the duration of the entire presentation can be announced in the playlist. Periodically this flag can be added to the media segment delivered to trigger playlist refresh by the end client. During each refresh, the playlist delivered to the end client can be modified.

Otherwise, the presentation can be treated and published as a live event, requiring the end client to refresh the playlist to obtain latest content. For each client, state corresponding to the last set of segments announced is maintained at the proxy (e.g., last sequence number delivered) and the playlist updated to include the next set of segments (just like a live event). Standard state mechanisms such as HTTP cookies can be utilized.

An explicit mechanism could be used to trigger a playlist refresh even for presentations that are published as “static” or non-live events.

In some embodiments, to control network traffic and perform traffic shaping, segments corresponding to high bitrates can be removed. Similarly, segments containing 3D content can be removed and/or replaced with those containing corresponding 2D content to shape network traffic or if the end client does not support (or is not entitled to) 3D content. The decision on when to perform (and relax) traffic shaping is orthogonal to this disclosure and can be driven by a target bandwidth rate (for the entire system or per stream), by group policy, through an explicit trigger (e.g., through an admin console), or based on end client subscriptions and/or feedback.

In some embodiments, a proxy such as that described herein may be used as part of an automated traffic management system, integrated with bandwidth monitoring and policy engine components.

In some embodiments, when no traffic shaping is to be performed, a playlist can be forward to the end client without modification.

This approach can also be used to provide differentiated service. For instance, depending on client type certain segments can be removed from a playlist (e.g., advertisements for premium clients or HD/high bitrate content for free users). The mechanism employed to differentiate between clients is orthogonal to this disclosure and can be based on service policies, user credentials, or device profiles. Content control and filtering can also be implemented by removing segments with particular properties from a playlist.

The URLs and/or URIs of the media segments listed in a playlist can also be changed in this approach. This can be done to change the content delivery network (“CDN”) used for media delivery (e.g., use CDN A for certain clients or CDN B during certain times/load factors). Even the media delivery protocol or distribution mechanism for certain segments can be changed (e.g., use P2P for high bitrate content or switch from unicast to broadcast or multicast).

In some embodiments, this approach facilitates ad insertion. At appropriate points in a playlist (e.g., at segment boundaries where client can expect media properties to change), identifiers corresponding to ads can be inserted into a playlist. In contrast to server-side ad insertion, no transcoding is required; the ad stitch-in takes place at the end client.

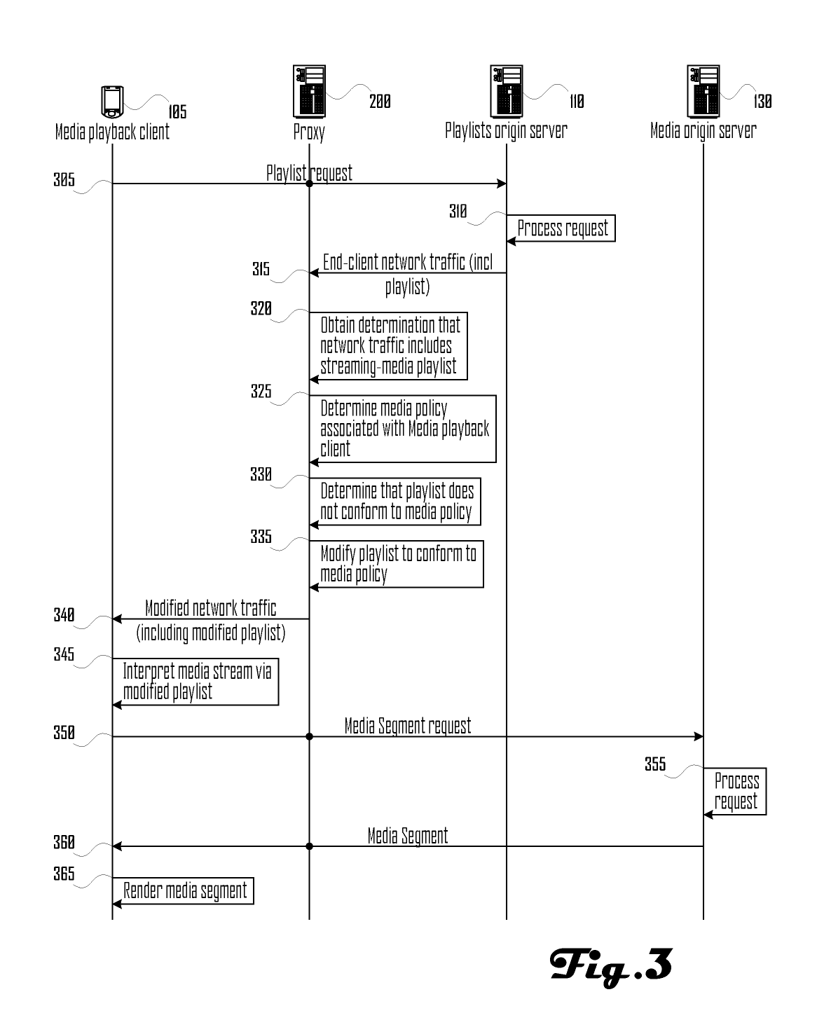

FIG. 3 illustrates an exemplary series of application-layer communications between media playback client 105, proxy 200, playlists origin server 110, and media origin server 130, in accordance with one embodiment. In the illustrated sequence of communications, proxy 200 redefines an adaptive HTTP media stream by modifying a playlist destined for media playback client 105.

Beginning the illustrated sequence of communications, media playback client 105 sends a request 305 for a streaming-media playlist that defines (at least a portion of) an adaptive HTTP audio and/or video media stream by identifying a plurality of brief media-content segments (hosted by media origin server 130) that sequentially make up the adaptive HTTP media stream. Typically, a “brief” media-content segment may range in length from a few seconds to a few minutes, with about ten seconds being a common duration. In the illustrated embodiment, request 305 may include a Hypertext Transfer Protocol (“HTTP”) request message identifying a playlist resource.

Playlists origin server 110 processes 310 the request and provides the requested playlist by sending network traffic 315 destined for media playback client 105 through proxy 200. In the illustrated embodiment, network traffic 315 includes an HTTP transaction message comprising one or more response headers and HTTP message body data including some or all of the requested playlist.

Proxy 200 receives the client-destined network traffic and obtains a determination that the network traffic includes the streaming-media playlist. For example, in some embodiments, such a determination may be made based on a response header, which may indicate a media type or content type associated with a known type of streaming media playlist, and/or based on the message body data, which may include a pattern of text or other content that identifies the message body as a known type of streaming media playlist. In some embodiments, proxy 200 may make this determination itself, while in other embodiments, another device (not shown) may make this determination and notify proxy 200 of the determination. In some embodiments, obtaining this determination includes interpreting the network traffic at the application layer (e.g., as HTTP messages) of the Internet protocol suite (“TCP/IP”) and/or the Open Systems Interconnection model (“OSI model”) of computer networking.

Having received the client-destined network traffic, proxy 200 determines 325 a media policy associated with media playback client 105. For example, in various embodiments, proxy 200 may consult policy manager 135, an internal policy management process, and/or any other suitable policy management system. In some embodiments, a policy management system may take into account factors such as a subscription level associated with the downstream client, current network congestion conditions, the type of media described in the playlist, the origin of the media described in the playlist, and other like factors.

Having determined a media policy associated with media playback client 105, proxy 200 determines 330 that the playlist in the network traffic does not conform to the media policy. For example, in one embodiment, if the downstream client is associated with a “free” subscription level and/or if network congestion is currently high, then the media policy may place a limit on the allowable bandwidth for the media described in the playlist. Conversely, if the downstream client is associated with a “paid” subscription level and/or if network congestion is currently low, then the media policy may allow higher bandwidth for the media described in the playlist.

Having determined that the playlist in the network traffic does not conform to the media policy, proxy 200 modifies 335 the playlist according to the media policy for the downstream client. For example, in one embodiment, proxy 200 may remove higher-bandwidth media-segment options from the playlist. In another embodiment, proxy 200 may insert one or more advertising media-segments into the playlist. Proxy 200 modifies the network traffic to include the modified playlist and passes the modified network traffic 340 towards media playback client 105.

Media playback client 105 thus interprets 345 the media stream defined by the requested playlist according to the modifications made by proxy 200. For example, in one embodiment, the modified playlist may include only media segments that are allowed by the current media policy for media playback client 105.

Media playback client 105 sends to media origin server 130 a request 350 for a media segment described in the modified playlist. Media origin server 130 processes 355 the request and provides the requested media segment 360 to media playback client 105 for rendering 365.

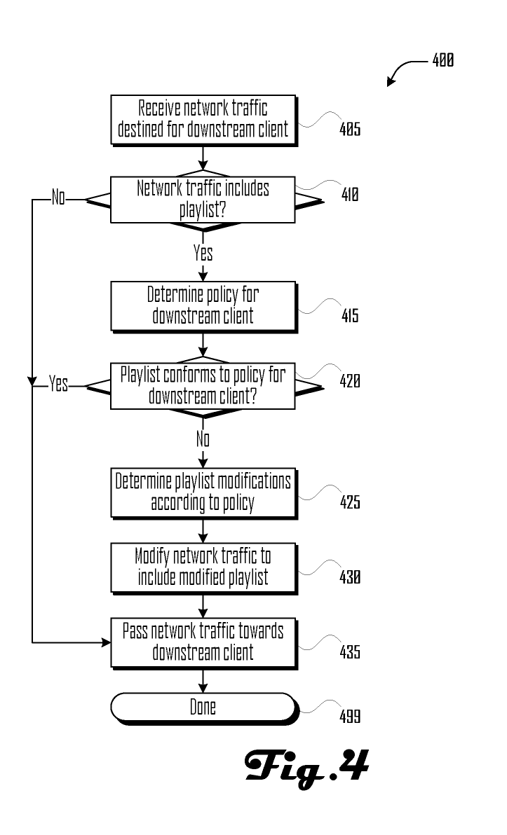

FIG. 4 illustrates an exemplary playlist modification routine 400, in accordance with one embodiment. In some embodiments, routine 400 may be performed by proxy 200 in connection with playlist-modification scenarios such as that illustrated in FIG. 3, discussed above.

In block 405, routine 400 receives network traffic (e.g., from playlists origin server 110 or other origin server on network 150, as illustrated in FIG. 1) destined for a downstream media-playback client (e.g., end clients 105A-C or other client device on carrier network 155, as illustrated in FIG. 1).

In decision block 410, routine 400 determines whether the network traffic destined for the downstream client includes a playlist. If not, then in block 435, routine 400 passes the network traffic towards the downstream client unmodified (although in some cases, other proxies and/or processes may subsequently modify the data in the network before it is received by the downstream client).

However, if in block 410, routine 400 determines that the network traffic includes a playlist, then in block 415, routine 400 determines a media policy for the downstream client. In various embodiments, any policy management system may be used to determine such a media policy. In some embodiments, a policy management system may take into account factors such as a subscription level associated with the downstream client, current network congestion conditions, the type of media described in the playlist, the origin of the media described in the playlist, and other like factors.

In block 420, routine 400 determines whether the playlist in the network traffic conforms to the determined media policy for the downstream client. For example, in one embodiment, if the downstream client is associated with a “free” subscription level and/or if network congestion is currently high, then the media policy may place a limit on the allowable bandwidth for the media described in the playlist. Conversely, if the downstream client is associated with a “paid” subscription level and/or if network congestion is currently low, then the media policy may allow higher bandwidth for the media described in the playlist.

If the playlist in the network traffic already conforms to the determined media policy for the downstream client, then in block 435, routine 400 passes the network traffic (including the unmodified playlist) towards the downstream client.

However, if the playlist in the network traffic does not conform to the determined media policy for the downstream client (e.g., the playlist includes higher-bandwidth media segments than allowed by the policy), then in block 425, routine 400 determines a playlist modification according to the media policy for the downstream client. For example, in one embodiment, routine 400 may determine that higher-bandwidth media-segment options should be removed from the playlist.

In another embodiment, routine 400 may determine that the playlist should be modified such that media-segment identifiers indicating media segments as being accessible in a first container format (e.g., MPEG transport stream or MPEG-TS) should be modified to indicate that those media segments are accessible in a second container format (e.g., MPEG-4 Part 14 or MP4). Modifying the playlist's media-segment identifiers in this manner may be desirable in cases where the second container format may be able to encapsulate the same media segments (without transcoding) as the first container format, but the second container format may do so more efficiently than the first container format.

In some embodiments, in addition to modifying the playlist to indicate that the media segments are accessible in a second container format, routine 400 may obtain some or all of the media segments in the first container format from an upstream media server, repacketize the obtained media segments into the second container format, and provide the repacketized segments upon request by the downstream client. Such non-transcoding repacketization is described in greater detail in U.S. patent application Ser. No. 12/838,325, titled MULTI-OUT MEDIA DISTRIBUTION SYSTEM AND METHOD, filed Jul. 16, 2010, having attorney docket number REAL-2010217 (RN312), and naming the following inventors: Aashima Narula, Steve McMillen, and Chytanya Karusala. The above-cited application is hereby incorporated by reference, in its entirety, for all purposes.

In yet another embodiment, routine 400 may determine that the playlist should be modified such that media-segment identifiers indicating media segments as being accessible via a unicast streaming protocol should be modified to indicate that the media stream defined by the playlist is accessible via a multicast streaming protocol. In such an embodiment, routine 400 may replace some or all of the unicast-protocol media-segment identifiers with one or more identifiers according to which a client device can access the media stream via a multicast streaming protocol.

In some embodiments, in addition to modifying the playlist to indicate that the media stream defined by the playlist is accessible via a multicast streaming protocol, routine 400 may obtain some or all of the media segments from an upstream media server, repacketize the obtained media segments (similar to the container-format repacketization process discussed above), and provide the repacketized segments via a multicast streaming protocol.

In yet another embodiment, routine 400 may determine that the playlist should be modified such that media-segment identifiers indicating media segments as being accessible via a non-peer-to-peer streaming protocol should be modified to indicate that the media stream defined by the playlist is accessible via a peer-to-peer streaming protocol. In such an embodiment, routine 400 may replace some or all of the non-peer-to-peer-protocol media-segment identifiers with one or more identifiers according to which a client device can access a the media stream via a peer-to-peer streaming protocol.

In other embodiments, routine 400 may determine other modifications.

In block 430, routine 400 modifies the network traffic such that the modified network traffic includes a modified playlist that conforms to the media policy determined for the downstream client. Then, in block 435, routine 400 passes the (modified) network traffic including the modified playlist towards the downstream client. Thus, the downstream client will see a playlist that includes only media segments that are allowed by its current media policy. When the downstream client requests a media segment described in the modified playlist, the media segment may be delivered to the downstream client unmodified (assuming that the downstream client's media policy has not changed according to dynamic conditions, such as network congestion).

Routine 400 ends in block 499.

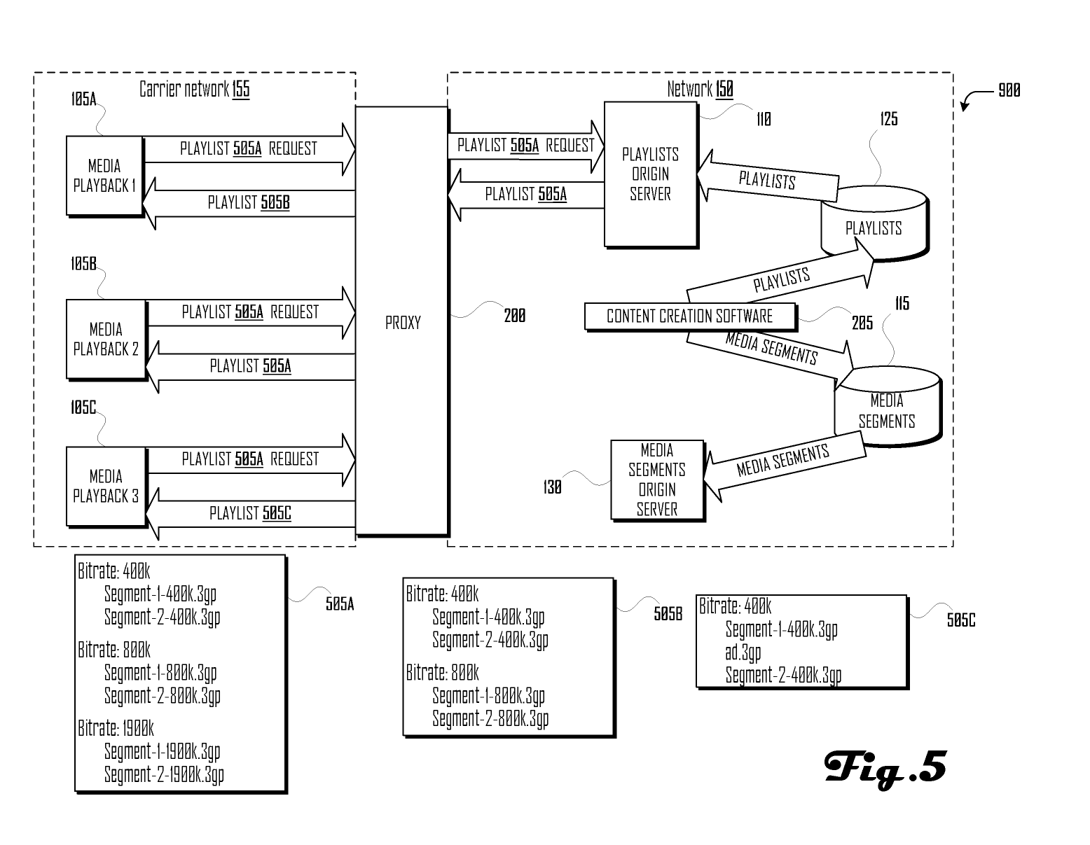

FIG. 5 illustrates an exemplary scenario in which proxy 200 processes playlist requests for various clients in accordance with one embodiment.

As illustrated in FIG. 5a, during the course of a streaming media presentation, proxy 200 modifies the example playlist 505A into alternate versions 505B and 505C to redefine the media stream for end client 105A and end client 105C. Media segment requests from the end clients are not shown. At another time, proxy 200 might make different (or no) modifications, depending on the current media policies for end clients 105A-C.

In FIG. 5, content creation software 205 (which may be executed on content creator 120) generates playlists for playlist data store 125 and media segments for media segment data store 115. In live-streaming embodiments, the playlists and media segments may be generated “on the fly,” as a live event occurs. In video-on-demand embodiments, the playlists and media segments may be generated offline and stored in data stores 125 and 115, respectively, for later streaming.

Example playlist 505A identifies media segments at three different bitrates. Playlist 505B omits the highest bitrate media segments. Playlist 505C includes only the lowest bitrate media segments and additionally inserts an advertisement segment between the media segments.

In some embodiments, the proxy can modify requests for media segments sent to the origin server. This can be done to enforce traffic shaping or differentiated service for live as well as on-demand streams.

To perform traffic shaping, the proxy can transform requests from end clients for high bitrate segments into requests for lower bitrate segments before forwarding them to the origin server. Similarly, requests for 3D content can be transformed by the proxy into requests for corresponding 2D content. The origin server response is forwarded to the end client without modification. For differentiated service, based on the end client, certain requests to the origin server can be modified (e.g., request for high bitrate media segments or 3D content for free clients), while others forwarded without modification.

Both the playlist and request modification approaches can be used to effect admission control during sudden increases in traffic (e.g., flash crowd events).

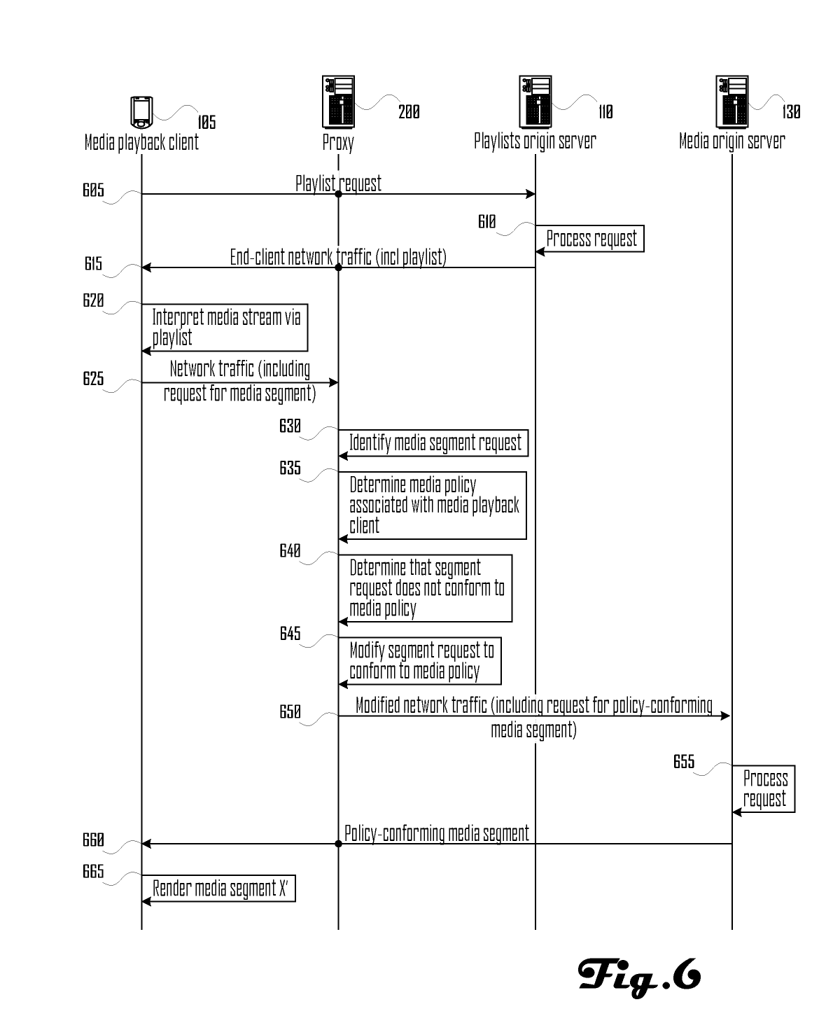

FIG. 6 illustrates an exemplary series of application-layer communications between media playback client 105, proxy 200, playlists origin server 110, and media origin server 130, in accordance with one embodiment. In the illustrated sequence of communications, proxy 200 redefines an adaptive HTTP media stream by modifying a media segment request made by media playback client 105.

Beginning the illustrated sequence of communications, media playback client 105 sends a request 605 for a streaming-media playlist that defines (at least a portion of) an adaptive HTTP audio and/or video media stream by identifying a plurality of brief media-content segments (hosted by media origin server 130) that sequentially make up the adaptive HTTP media stream. In the illustrated embodiment, request 605 may include a Hypertext Transfer Protocol (“HTTP”) request message identifying a playlist resource.

Playlists origin server 110 processes 610 the request and provides the requested playlist by sending network traffic 615 destined for media playback client 105 through proxy 200. In the illustrated embodiment, network traffic 615 includes an HTTP transaction message comprising one or more response headers and HTTP message body data including some or all of the requested playlist.

Media playback client 105 interprets 620 the media stream defined by the requested playlist and sends network traffic 625 destined for media origin server 130 via proxy 200, the network traffic including a request for a media segment comprising a brief portion of the media stream. For example, in one embodiment, the network traffic may include an HTTP GET request including a resource identifier identifying the media segment (e.g., “GET /streamX/800k/segment-1.3gp HTTP/1.1”).

Proxy 200 receives the origin-server-destined network traffic and obtains a determination that the network traffic includes a request for a streaming media segment. For example, in some embodiments, such a determination may be made based on the requested resource identifier, which may include a pattern of text (e.g., “.3gp”) or other data that identifies the requested resource as a known type of streaming media segment. The request may further include a pattern of text or other data that indicates a bandwidth level, access protocol, or other metadata about a quality and/or service level associated with the requested media segment.

In some embodiments, proxy 200 may make this determination itself, while in other embodiments, another device (not shown) may make this determination and notify proxy 200 of the determination. In some embodiments, obtaining this determination includes interpreting the network traffic at the application layer (e.g., as HTTP messages) of the Internet protocol suite and/or the OSI model of computer networking.

Having determined that the network traffic includes a request for a streaming media segment, proxy 200 determines 635 a media policy associated with media playback client 105. For example, in various embodiments, proxy 200 may consult policy manager 135, an internal policy management process, and/or any other suitable policy management system. In some embodiments, a policy management system may take into account factors such as a subscription level associated with the downstream client, current network congestion conditions, the type of media described in the playlist, the origin of the media described in the playlist, and other like factors.

Having determined a media policy associated with media playback client 105, proxy 200 determines 630 that the media segment request does not conform to the media policy. For example, in one embodiment, if the downstream client is associated with a “free” subscription level and/or if network congestion is currently high, then the media policy may place a limit on the allowable bandwidth for the media described in the playlist. Conversely, if the downstream client is associated with a “paid” subscription level and/or if network congestion is currently low, then the media policy may allow higher bandwidth for the media described in the playlist.

Having determined that the requested media segment does not conform to the determined media policy for the media playback client 105 (e.g., the requested media segment has a higher-bandwidth than allowed by the policy), proxy 200 modifies 645 the segment request to request a segment that conforms to the media policy for the downstream client. For example, in one embodiment, proxy 200 may modify the request to identify a lower-bandwidth media segment (e.g., “GET /streamX/400k/segment-1.3gp HTTP/1.1”) should be requested in place of the originally-requested media segment.

Having modified the media segment request, proxy 200 passes the modified network traffic (including the modified request) towards media origin server 130, which processes 655 the request and provides the policy-conforming segment 660 per the modified request for media playback client 105 to render 665.

FIG. 7 illustrates an exemplary series of application-layer communications between media playback client 105, proxy 200, playlists origin server 110, and media origin server 130, in accordance with one embodiment. In the illustrated sequence of communications, proxy 200 redefines an adaptive HTTP media stream by modifying a media segment request made by media playback client 105. Communications 705-740 are respectively identical to communications 605-640, as shown in FIG. 6 and discussed above. The series of communications shown in FIG. 7 begins to differ from FIG. 6 when proxy 200 determines 745 a policy-conforming media segment identifier. For example, in one embodiment, proxy 200 may determine an identifier identifying a lower-bandwidth media segment (e.g., “/streamX/400k/segment-1.3gp”).

Having determined a policy-conforming media segment identifier, proxy 200 sends to media playback client 105 a redirect 750 indicating that the requested media segment resource has moved (e.g., “HTTP/1.1 301 Moved Permanently\nLocation: http://media-origin-server.com/streamX/400k/segment-1.3gp . . . ”).

Media playback client 105 processes the redirect and sends network traffic 755 including a request for the policy-conforming media segment (e.g., (e.g., “GET /streamX/400k/segment-1.3gp HTTP/1.1”) towards media origin server 130, which processes 760 the request and provides the policy-conforming segment 765 for media playback client 105 to render 770.

FIG. 8 illustrates a media-segment-request modification routine 800 in accordance with one embodiment. In some embodiments, routine 800 may be performed by proxy 200 in connection with media-segment-request-modification embodiments, such as those illustrated in FIGS. 6-7, discussed above).

In block 805, routine 800 receives network traffic from a downstream media-playback client (e.g., media playback clients 105A-C or other client device on carrier network 155, as illustrated in FIG. 1).

In decision block 810, routine 800 obtains a determination of whether the network traffic from the downstream client includes a request for a media segment from a media segment origin server (e.g., from media segments origin server 130 or other origin server on network 150, as illustrated in FIG. 1). For example, in some embodiments, such a determination may be made based on the requested resource identifier, which may include a pattern of text (e.g., “.3gp”) or other data that identifies the requested resource as a known type of streaming media segment. The request may further include a pattern of text or other data that indicates a bandwidth level, access protocol, or other metadata about a quality and/or service level associated with the requested media segment. If the network traffic does not include a request for a media segment, then in block 835, routine 800 passes the network traffic (unmodified) upstream.

However, if in block 810, routine 800 determines that the network traffic includes a request for a media segment, the request destined for an upstream media origin server, then in block 815, routine 800 determines a media policy for the downstream client. In various embodiments, any policy management system may be used to determine such a media policy. In some embodiments, a policy management system may take into account factors such as a subscription level associated with the downstream client, current network congestion conditions, the type of media requested, the origin of the requested media segment, and other like factors.

In block 820, routine 800 determines whether the requested media segment conforms to the determined media policy for the downstream client. For example, in one embodiment, if the downstream client is associated with a “free” subscription level and/or if network congestion is currently high, then the media policy may place a limit on the allowable bandwidth for the requested media segment. Conversely, if the downstream client is associated with a “paid” subscription level and/or if network congestion is currently low, then the media policy may allow higher bandwidth for the requested media segment.

If the requested media segment already conforms to the determined media policy for the downstream client, then in block 835, routine 800 passes the network traffic (including the unmodified request) upstream.

However, if the requested media segment does not conform to the determined media policy for the downstream client (e.g., the requested media segment has a higher-bandwidth than allowed by the policy), then in block 835, routine 800 determines a policy-conforming media segment according to the media policy for the downstream client. For example, in one embodiment, routine 800 may determine that a lower-bandwidth media segment should be requested in place of the originally-requested media segment.

In block 830, routine 800 modifies the media-segment request such that the modified request identifies a media segment that conforms to the media policy determined for the downstream client. In some embodiments, routine 800 may send a modified request to the upstream media origin server, while in other embodiments, routine 800 may redirect the downstream media-playback client to the policy-conforming media segment.

When the upstream origin server delivers the policy-conforming media segment, the delivered media segment traffic may be passed on to the downstream client unmodified. Thus, the downstream client may ultimately be able to obtain only media segments that are allowed by its current media policy.

Routine 800 ends in block 899.

In some embodiments, a proxy may have difficulty modifying a playlist destined for a media-playback client if the client accesses the playlist via a secure communication protocol (e.g., Hypertext Transfer Protocol Secure or “HTTPS”). However, in some cases, a non-secure communications protocol (e.g., HTTP) may be used to transmit a Uniform Resource Locator (“URL”) or other resource identifier identifying a securely-accessible playlist. In such cases, a proxy may be able to modify the transmission of a playlist resource identifier, so that traffic shaping based on playlist modifications (as discussed variously herein) may still be employed.

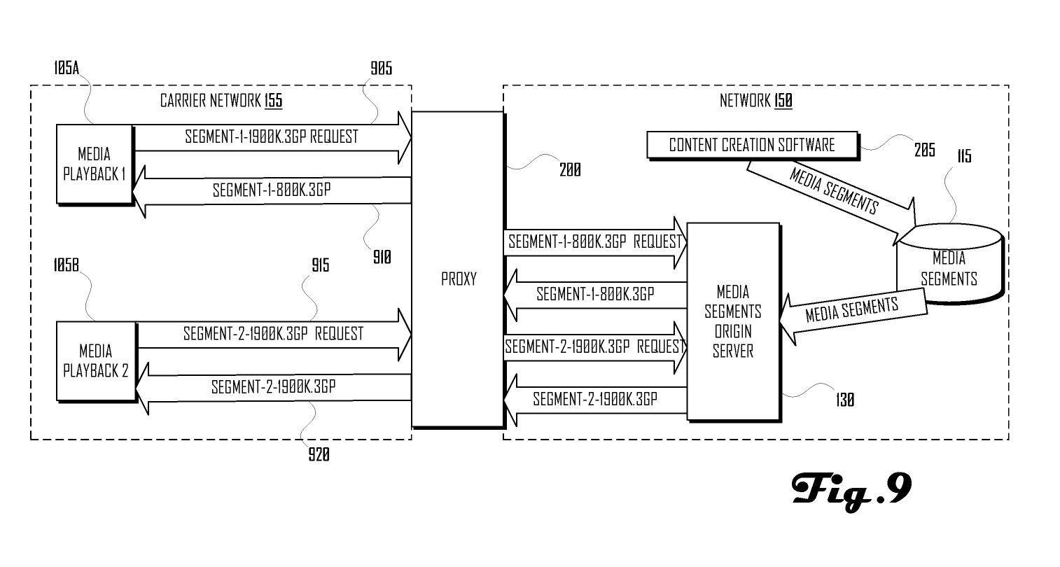

FIG. 9 illustrates an exemplary scenario in which proxy 200 processes media segment requests from various clients in accordance with one embodiment.

As illustrated in FIG. 9, during the course of a streaming media presentation, proxy 200 receives from media playback client 105A request 905 for a 1900 kilobit media segment. Media playback client 105A has a restrictive media policy, so proxy 200 delivers segment 910, which as an 800 kilobit version of the same media segment. By contrast, media playback client 105B has a more permissive media policy than client 105A, so in response to request 915, proxy 200 forwards the requested 1900 kilobit media segment. At other times during the streaming media presentation, the playback clients may have other current media policies, so at other times proxy 200 may treat similar requests differently.

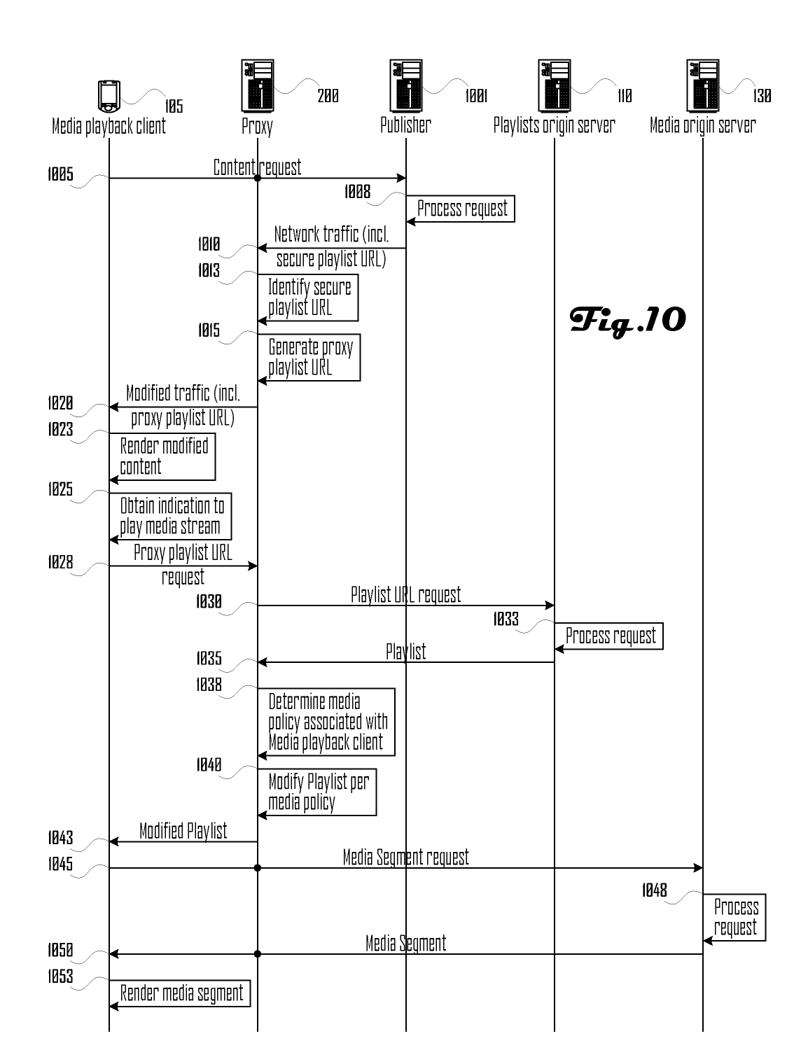

FIG. 10 illustrates an exemplary series of application-layer communications between media playback client 105, proxy 200, publisher 1001, playlists origin server 110, and media origin server 130, in accordance with one embodiment. In the illustrated sequence of communications, proxy 200 redefines an adaptive HTTP media stream by modifying a media playlist after modifying the transmission of a securely-accessible playlist resource identifier.

Beginning the illustrated sequence of communications, media playback client 105 sends to publisher 1001 a content request 1005 requesting a web page or other content that may include a playlist resource identifier.

Publisher 1001 processes 1008 the request and provides the requested content by sending network traffic 1010 destined for media playback client 105 through proxy 200. In the illustrated embodiment, network traffic 1010 includes a resource identifier identifying a streaming media playlist that is accessible via a secure access scheme (e.g., “https://playlist-origin-server.com/streamX/playlist.m3u8”).

Proxy 200 receives the client-destined network traffic and obtains a determination that the network traffic includes the securely-accessible playlist resource identifier. For example, in some embodiments, such a determination may be made based on message body data, which may include a pattern of text or other content that identifies a known type of streaming media playlist and that indicates a secure access scheme for that playlist. In some embodiments, proxy 200 may make this determination itself, while in other embodiments, another device (not shown) may make this determination and notify proxy 200 of the determination. In some embodiments, obtaining this determination includes interpreting the network traffic at the application layer (e.g., as HTTP messages) of the Internet protocol suite and/or the OSI model of computer networking.

Having determined that the network traffic includes a resource identifier identifying a securely-accessible playlist resource, proxy 200 generates a proxy playlist resource identifier (e.g. “http://proxy.com/?securePlaylistURL=https %3A%2F %2Fplaylist-origin-server.com %2FstreamX %2Fplaylist.m3u8”) associated with the securely-accessible playlist resource identifier and passes towards media playback client 105 modified network traffic 1020, which includes the proxy playlist resource identifier in place of the securely-accessible playlist resource identifier.

Media playback client 105 receives and renders 1025 the content represented by the modified network traffic. For example, in one embodiment, media playback client 105 might render a web page including a link to the proxy playlist resource identifier.

Having rendered the modified content, media playback client 105 obtains an indication to render a media stream associated with the proxy playlist resource identifier. For example, in one embodiment, a user of media playback client 105 might activate the link to the proxy playlist resource identifier using a pointing device or by other means.

Having received the indication to render the media stream, media playback client 105 sends to proxy 200 a request 1028 for the resource identified by the proxy playlist resource identifier. In turn, proxy 200 sends to playlists origin server 110 a secure-scheme request 1030 for the playlist resource identified by the securely-accessible playlist resource identifier. Playlists origin server 110 processes the request and securely sends to proxy 200 the requested playlist 1035.

Having received the securely-accessible playlist, proxy 200 determines 1038 a media policy associated with media playback client 105 and modifies 335 the playlist according to the media policy in a manner similar to that described above.

Proxy 200 provides the modified playlist 1043 to media playback client 105. When media playback client 105 sends to media origin server 130 a request 1045 for a media segment identified in the modified playlist, media origin server 130 processes 1048 the request and provides the requested media segment 1050 to media playback client 105 for rendering 1053.

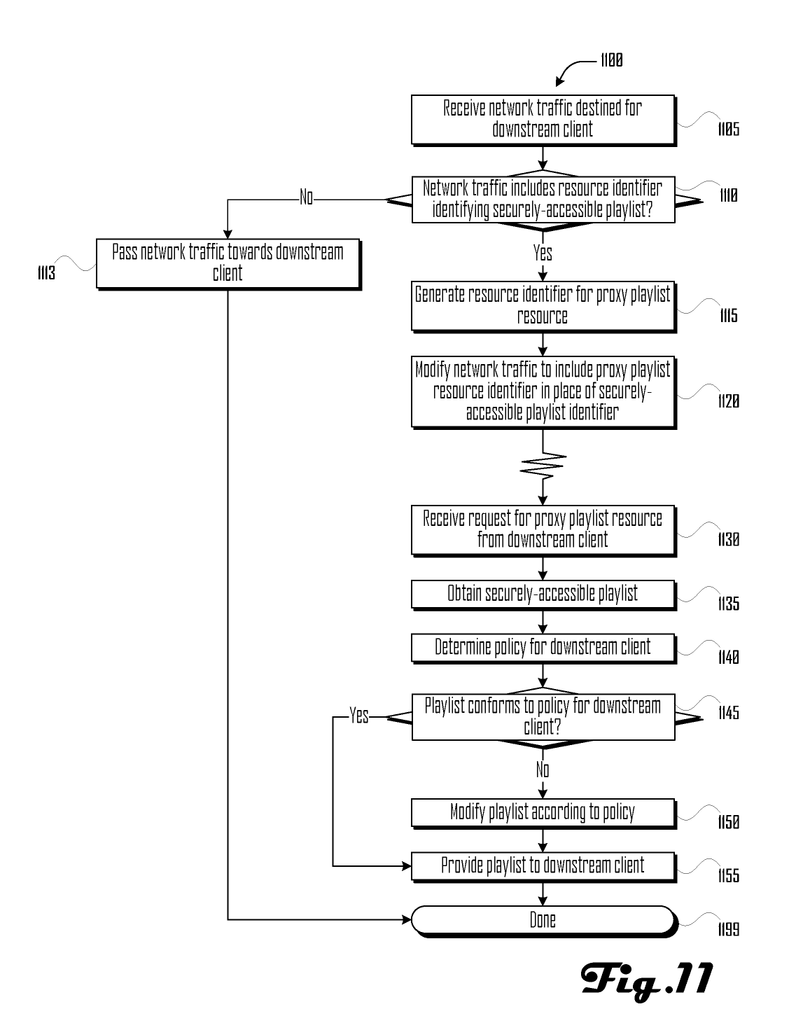

FIG. 11 illustrates a securely-accessible playlist modification routine 1100 in accordance with one embodiment. In some embodiments, routine 1100 may be performed by proxy 200 in connection with securely-accessible playlist modification embodiments, such as that discussed above in reference to FIG. 9.

In block 1105, routine 1100 receives network traffic destined for a downstream media-playback client (e.g., media playback clients 115A-C or other client device on carrier network 155, as illustrated in FIG. 1).

In decision block 1110, routine 1100 obtains a determination of whether the network traffic includes a resource identifier identifying a streaming media playlist that is accessible via a secure access scheme (e.g., “https://playlist-origin-server.com/streamX/playlist.m3u8”).

For example, in some embodiments, such a determination may be made based in part on the presence or absence of such a resource identifier, which may include a pattern of text (e.g., “.m3u8”) or other data that indicates that an identifier identifies a streaming media playlist. Such a determination may also be made based in part on the presence or absence of a secure access scheme (e.g., “https”) in the identifier.

If the network traffic does not include a resource identifier identifying a securely-accessible streaming media playlist, then in block 1113, routine 1100 passes the network traffic (unmodified) towards the downstream media-playback client.

Otherwise, if the network traffic includes a resource identifier identifying a securely-accessible streaming media playlist, then in block 1115, routine 1100 generates a proxy resource identifier (e.g. “http://proxy.com/?securePlaylistURL=https %3A %2F %2Fplaylist-origin-server.com %2FstreamX %2Fplaylist.m3u8”) associated with the securely-accessible playlist resource, the proxy resource identifier identifying a proxy playlist resource available from the device performing routine 1100. The proxy playlist resource thus identified need not actually exist at the time the proxy resource identifier is created, and the proxy resource identifier may specify either a secure or a non-secure access scheme for the proxy playlist resource.

At some subsequent point, routine 1100 receives in block 1130 a request from the downstream media-playback client for the proxy playlist resource identified by the proxy resource identifier.

In response to receiving the request, in block 1135, routine 1100 requests and securely receives the securely-accessible playlist resource (with which the proxy resource identifier is associated) from an upstream playlist origin server.

In block 1140, routine 1100 determines a media policy for the downstream client. In various embodiments, any policy management system may be used to determine such a media policy. In some embodiments, a policy management system may take into account factors such as a subscription level associated with the downstream client, current network congestion conditions, the type of media requested, the origin of the requested media segment, and other like factors.

In decision block 1145, routine 1100 determines whether the securely-accessible playlist conforms to the determined media policy for the downstream client. For example, in one embodiment, if the downstream client is associated with a “free” subscription level and/or if network congestion is currently high, then the media policy may place a limit on the allowable bandwidth for the media stream defined by the securely-accessible playlist. Conversely, if the downstream client is associated with a “paid” subscription level and/or if network congestion is currently low, then the media policy may allow higher bandwidth for the media stream defined by the securely-accessible playlist.

If the securely-accessible playlist already defines a media stream that conforms to the determined media policy for the downstream client, then in block 1155, routine 1100 provides the securely-accessible playlist unmodified to the downstream media-playback client according to the access scheme specified by the proxy resource identifier.

However, if the securely-accessible playlist already defines a media stream that does not conform to the determined media policy (e.g., the defined media stream has a higher-bandwidth than allowed by the policy), then in block 1150, routine 1100 modifies the securely-accessible playlist such that it defines a media stream that conforms to the media policy for the downstream client. For example, in one embodiment, routine 1100 may determine that higher-bandwidth media-segment options should be removed from the playlist. In another embodiment, routine 1100 may determine that one or more advertising media-segments should be inserted into the playlist. In other embodiments, routine 1100 may determine other modifications.

In block 1155, routine 1100 provides the modified securely-accessible playlist to the downstream media-playback client according to the access scheme specified by the proxy resource identifier. Routine 1100 ends in block 1199.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A computer-implemented method for adaptively managing media traffic, the method comprising:
receiving, by an application-layer proxy server, network traffic destined for a downstream media playback device;
obtaining, by said proxy server, a determination that said network traffic includes a streaming-media playlist that defines at least a portion of an adaptive HTTP audio and/or video stream by identifying a plurality of brief media-content segments, hosted by an upstream media-content origin server, that sequentially make up at least said portion of said adaptive HTTP audio and/or video stream;
determining, by said proxy server, whether said streaming-media playlist conforms to a media policy associated with said downstream media playback device; and
when said streaming-media playlist does not conform to said media policy, said proxy server:
determining a playlist modification according to said media policy, said playlist modification redefining at least said portion of said adaptive HTTP audio and/or video stream by modifying said streaming-media playlist at the brief-media-content-segment level; and
modifying said network traffic according to said playlist modification, such that the modified network traffic includes a modified streaming-media playlist that conforms to said media policy.

2. The method of claim 1, wherein said plurality of brief media-content segments includes a first subset of brief media-content segments and a second subset of brief media-content segments, said first subset of brief media-content segments sequentially making up a first encoding of said portion of said adaptive HTTP audio and/or video stream, said second subset of brief media-content segments sequentially making up a second encoding of said portion of said adaptive HTTP audio and/or video stream, and wherein modifying said streaming-media playlist at the brief-media-content-segment level comprises removing said second subset of brief media-content segments.

3. The method of claim 2, wherein said second encoding of said portion of said adaptive HTTP audio and/or video stream is encoded at a higher quality level than said first encoding of said portion of said adaptive HTTP audio and/or video stream.

4. The method of claim 1, wherein modifying said streaming-media playlist at the brief-media-content-segment level comprises inserting a new segment identifier identifying a new brief media-content segment into said streaming-media playlist at an existing segment boundary.

5. The method of claim 4, wherein said new brief media-content segment comprises advertising audio and/or video content.

6. The method of claim 1, wherein said streaming-media playlist includes a plurality of media-segment identifiers respectively corresponding to said plurality of brief media-content segments, said plurality of media-segment identifiers indicating a first streaming protocol by which said downstream media playback device can obtain said plurality of brief media-content segments, and wherein modifying said streaming-media playlist at the brief-media-content-segment level comprises modifying said plurality of media-segment identifiers to indicate a second streaming protocol by which said downstream media playback device can obtain said plurality of brief media-content segments.

7. The method of claim 1, wherein said streaming-media playlist includes a plurality of media-segment identifiers respectively corresponding to said plurality of brief media-content segments, said plurality of media-segment identifiers indicating a first container format in which said downstream media playback device can obtain said plurality of brief media-content segments, and wherein modifying said streaming-media playlist at the brief-media-content-segment level comprises modifying said plurality of media-segment identifiers to indicate a second container format in which said downstream media playback device can obtain said plurality of brief media-content segments.

8. The method of claim 7, wherein said first container format comprises an MPEG transport stream container format, and wherein said second container format comprises an MPEG-4 Part 14 container format.

9. A non-transient computer readable storage medium storing instructions that, when executed by a processor, configure the processor to adaptively manage media traffic according to the method of claim 1.

10. An apparatus comprising a processor and a memory storing instructions that, when executed by the processor, configure the apparatus to adaptively manage media traffic according to the method of claim 1.

11. A computer-implemented method for adaptively managing media traffic, the method comprising:
receiving, by an application-layer proxy server, network traffic destined for a downstream media playback device;
obtaining, by said proxy server, a determination that said network traffic includes a streaming-media playlist defining at least a portion of a first stream of an audio and/or video work;
determining, by said proxy server, whether said streaming-media playlist conforms to a media policy associated with said downstream media playback device; and
when said streaming-media playlist does not conform to said media policy, said proxy server modifying said network traffic to include a modified streaming-media playlist that conforms to said media policy, said modified streaming-media playlist defining at least a portion of a second stream of said audio and/or video work.

12. The method of claim 11, wherein said streaming-media playlist defines said portion of said first stream according to a plurality of media-segment identifiers indicating a first streaming protocol, and wherein said modified streaming-media playlist includes at least one modified media-segment identifier indicating a second streaming protocol.

13. The method of claim 12, wherein said first streaming protocol comprises a unicast streaming protocol, and wherein said second streaming protocol comprises a multicast streaming protocol.

14. The method of claim 12, wherein said first streaming protocol comprises a client-server streaming protocol, and wherein said second streaming protocol comprises a peer-to-peer streaming protocol.

15. A non-transient computer readable storage medium storing instructions that, when executed by a processor, configure the processor to adaptively manage media traffic according to the method of claim 11.

16. An apparatus comprising a processor and a memory storing instructions that, when executed by the processor, configure the apparatus to adaptively manage media traffic according to the method of claim 11.

17. A computer-implemented method for adaptively managing media traffic, the method comprising:
receiving, by an application-layer proxy server, network traffic from a downstream media playback device;
determining, by said proxy server, whether said network traffic includes a media-segment request identifying a first brief media-content segment of an adaptive HTTP audio and/or video stream hosted by an upstream media-content origin server;
when said network traffic is determined to include said media-segment request, said proxy server determining whether said media-segment request conforms to a media policy associated with said downstream media playback device; and
when said media-segment request does not conform to said media policy, said proxy server:
determining a request modification according to said media policy, said request modification identifying a second brief media-content segment of said adaptive HTTP audio and/or video stream; and
modifying said network traffic according to said request modification, such that said modified network traffic includes a modified media-segment request that conforms to said media policy.

18. The method of claim 17, further comprising:
receiving from said upstream media-content origin server said second brief media-content segment of said adaptive HTTP audio and/or video stream; and
passing said second brief media-content segment of said adaptive HTTP audio and/or video stream towards said downstream media playback device.

19. The method of claim 17, wherein said adaptive HTTP audio and/or video stream comprises multiple encodings of an audio and/or video work, said first brief media-content segment being a sequential segment of a first encoding of said audio and/or video work, and wherein said second brief media-content segment is a sequential segment of a second encoding of said portion of said audio and/or video work.

20. A non-transient computer readable storage medium storing instructions that, when executed by a processor, configure the processor to adaptively manage media traffic according to the method of claim 17.

21. An apparatus comprising a processor and a memory storing instructions that, when executed by the processor, configure the apparatus to adaptively manage media traffic according to the method of claim 17.

22. A computer-implemented method for adaptively managing media traffic, the method comprising:
receiving, by an application-layer proxy server, network traffic destined for a downstream media playback device;
obtaining, by said proxy server, a determination that said network traffic includes a first resource identifier that identifies a streaming-media playlist hosted by an upstream origin server and that specifies a secure access scheme for accessing said streaming-media playlist, said streaming-media playlist defining at least a portion of an audio and/or video stream;
generating, by said proxy server, a second resource identifier identifying a proxy playlist resource hosted by said proxy server;
modifying said network traffic, by said proxy server, to include said second resource identifier in place of said first resource identifier;
after modifying said network traffic, said proxy server receiving from said downstream media playback device a request for said proxy playlist resource identified by said second resource identifier;
obtaining, by said proxy server, said streaming-media playlist from said origin server according to said first resource identifier;
determining, by said proxy server, whether said streaming-media playlist conforms to a media policy associated with said downstream media playback device; and
when said streaming-media playlist does not conform to said media policy, said proxy server:
modifying said streaming-media playlist according to said media policy; and
providing said modified streaming-media playlist to said downstream media playback device.

23. A non-transient computer readable storage medium storing instructions that, when executed by a processor, configure the processor to adaptively manage media traffic according to the method of claim 22.

24. An apparatus comprising a processor and a memory storing instructions that, when executed by the processor, configure the apparatus to adaptively manage media traffic according to the method of claim 22.
